(19) United States
(12) Patent Application Publication
(10) Pub. No.: US 2017/0260932 A1
(43) Pub. Date: Sep. 14, 2017

(54) FUEL TANK PRESSURE REGULATOR

(71) Applicant: Stant USA Corp., Connersville, IN (US)

(72) Inventors: Michael S. Brock, Connersville, IN (US); Kevin L. Young, Connersville, IN (US); John Brian Anderson, Liberty, IN (US)

(21) Appl. No.: 15/455,264

(22) Filed: Mar. 10, 2017

Related U.S. Application Data
(60) Provisional application No. 62/307,113, filed on Mar. 11, 2016.

(51) Int. Cl. F02M 25/08; B60K 15/035

(52) U.S. Cl. CPC F02M 25/0872; F02M 25/089; B60K 15/03504; B60K 15/03519; F02M 2025/0845; B60K 2015/0319

(57) ABSTRACT

A tank venting system in accordance with the present disclosure includes a vent apparatus for regulating flow of fuel vapor between a fuel tank and a fuel vapor recovery system in a vehicle. The flow of fuel vapor is controlled to maintain the pressure of fuel vapor in the fuel tank at a certain pressure level or within a certain pressure range during different modes of use.

### PRIORITY CLAIM

This application claims priority under 35 U.S.C. §119(e) to U.S. Provisional Application Ser. No. 62/307,113, filed Mar. 11, 2016, which is expressly incorporated by reference herein.

### BACKGROUND

The present disclosure relates to fuel tank vent valves, and particularly to venting apparatus for regulating discharge of fuel vapor from a fuel tank and admission of outside air into the fuel tank. More particularly, the present disclosure relates to a fuel tank pressure regulator including a fuel tank vent valve.

Vehicle fuel systems include valves associated with a fuel tank and are configured to vent pressurized or displaced fuel vapor from the vapor space in the fuel tank to a vapor recovery canister located outside of the fuel tank. The canister is designed to capture and store hydrocarbons entrained in fuel vapors that are displaced and generated in the fuel tank during a typical vehicle refueling operation or that are otherwise vented from the fuel tank.

### SUMMARY

A tank venting system in accordance with the present disclosure includes a vent apparatus for regulating flow of fuel vapor between a fuel tank and a fuel vapor recovery system in a vehicle. The flow of fuel vapor is controlled to maintain the pressure of fuel vapor in the fuel tank at a certain pressure level or within a certain pressure range during different modes of use.

In illustrative embodiments, the vent apparatus includes a pressure-controlled valve configured to regulate a relatively large volume of fuel vapor flow from a fuel tank to a fuel vapor recovery canister along a first vapor flow path and an electronically-controlled pressure bleed valve configured to regulate flow of a relatively small volume of fuel vapor flow from the fuel tank to the fuel vapor recovery canister along a second vapor flow path. By regulating the relatively small volume of fuel vapor flow from the fuel tank to the fuel vapor recovery canister, the electronically-controlled pressure bleed valve adjusts pressure applied to the pressure-activated valve such that opening and closing of the pressure-activated valve is controlled by the electronically-controlled pressure bleed valve.

In illustrative embodiments, the pressure-controlled valve is movable from a normally closed position arranged to block fuel vapor flow along the first vapor flow path to an opened position arranged to allow fuel vapor flow along the first vapor flow path. The pressure-controlled valve includes a deformable diaphragm that flexes in response to a pressure differential being applied to opposing sides of the pressure-controlled valve to move the pressure-controlled valve from the closed position to the opened position. A bias spring is configured to encourage the pressure controlled valve toward the normally closed position.

In illustrative embodiments, the electronically-controlled valve is movable from a closed position arranged to block fuel vapor flow along the second vapor flow path to an opened position arranged to allow fuel vapor flow along the second vapor flow path. The electronically-controlled valve includes a stopper configured to move into and out of a bleed passageway and an electro-magnetic actuator configured to move the stopper. A valve-mover controller is coupled to the electro-magnetic actuator to open and close the electronically-controlled valve under predetermined conditions.

Additional features of the present disclosure will become apparent to those skilled in the art upon consideration of the following detailed description of illustrative embodiments exemplifying the best mode of carrying out the invention as presently perceived.

### BRIEF DESCRIPTIONS OF THE DRAWINGS

The detailed description particularly refers to the accompanying figures in which:

FIG. 1 is a sectional perspective view of a tank venting system including a vent apparatus configured to control the flow of fuel vapor from a fuel tank to a fuel vapor recovery canister, showing that the vent apparatus comprises (1) a pressure-controlled valve configured to block or allow a relatively large volume of fuel vapor to flow from the tank passageway to the canister passageway through a first portion of a valve compartment to relieve unwanted tank pressure conditions as suggested in FIG. 7 and (2) an electronically-controlled pressure bleed valve configured to block or allow a relatively small volume of fuel vapor to flow to atmosphere through a second portion of the valve compartment to adjust pressure in the second portion of the valve compartment and thereby control pressures applied to the pressure-controlled valve as suggested in FIG. 6;

FIG. 2 is an exploded sectional perspective assembly view of the components included in the vent apparatus of FIG. 1 and showing that the vent apparatus includes (1) a multi-piece housing, (2) the pressure-controlled valve made up of a deformable diaphragm adapted to be mounted to the housing, a seal ring that seals against the housing, and a divider plate that interconnects the deformable diaphragm and the seal ring, and (3) the electronically-controlled pressure bleed valve having a movable stopper with an overmolded diaphragm and an electro-magnetic actuator configured to move the stopper from a closed position to an opened position as suggested in FIGS. 3-6;

FIG. 3 is a cross-sectional view of the tank venting system of FIG. 1 with the electronically-controlled pressure bleed valve in the closed position and the pressure-controlled valve in the closed position blocking fluid flow from the fuel tank to the fuel-vapor recovery canister;

FIG. 4 is an enlarged view of the circled portion of FIG. 3 showing the stopper of the electronically-controlled pressure bleed valve in the closed position with the overmolded diaphragm blocking flow of fuel vapor from the control pipe to the canister pipe through the upper portion of the valve compartment and the bleed pipe so that pressure in the upper portion of the valve compartment included in the pressure-controlled valve housing is pressurized by the fuel tank to match the pressure in the lower portion of the valve compartment thereby maintaining the pressure-controlled valve in the closed position;

FIG. 5 is view similar to FIG. 3 with the electronically-controlled pressure bleed valve in the opened position to allow a relatively small fluid flow from the fuel tank to the fuel-vapor recovery canister while the pressure-controlled valve is in the closed position blocking a relatively large fluid flow from the fuel tank to the fuel-vapor recovery canister;

FIG. 6 is an enlarged view of the circled portion of FIG. 5 showing the stopper of the electronically-controlled pressure bleed valve in the opened position allowing flow of fuel vapor from the control pipe to the canister pipe through the upper portion of the valve compartment and the bleed pipe so that pressure in the upper portion of the valve compartment is lowered below the pressure in the lower portion of the valve compartment thereby causing the pressure-controlled valve to move to the opened position as shown in FIG. 7;

FIG. 7 is view similar to FIGS. 3 and 5 with the electronically-controlled pressure bleed valve in the opened position to allow a relatively small fluid flow from the fuel tank to the fuel-vapor recovery canister and the pressure-controlled valve in the opened position allowing a relatively large fluid flow from the fuel tank to the fuel-vapor recovery canister; and

FIG. 8 is an enlarged view of the circled portion of FIG. 7 showing the electronically-controlled valve in the opened position.

### DETAILED DESCRIPTION

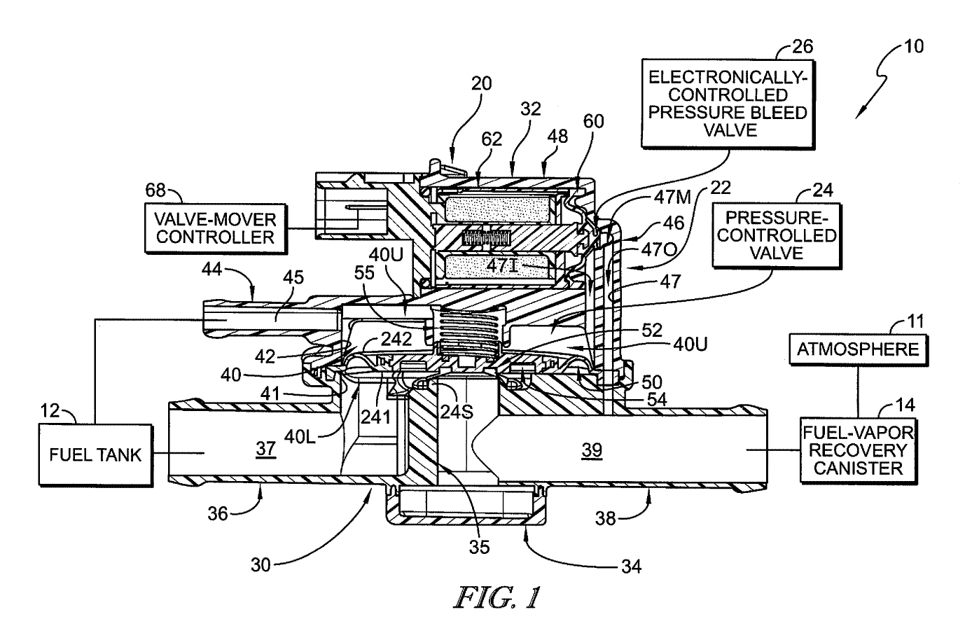

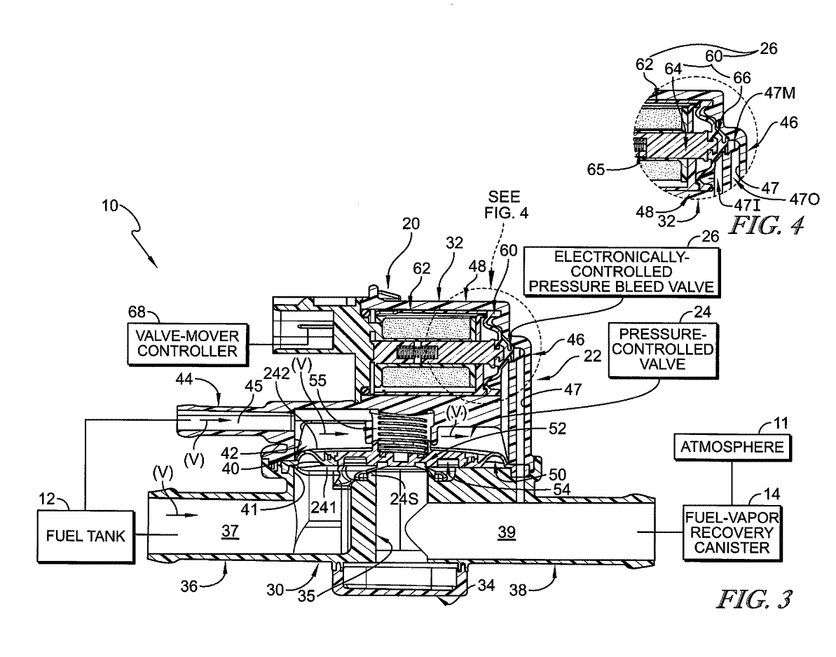

A tank venting system 10 is provided to control flow of air and fuel vapor between a fuel tank 12 and an emission control system including a fuel vapor recovery canister 14 as suggested in FIG. 1. System 10 is used onboard a vehicle (not shown) including an engine and a purge vacuum source coupled to engine and canister 14 as suggested in FIG. 3.

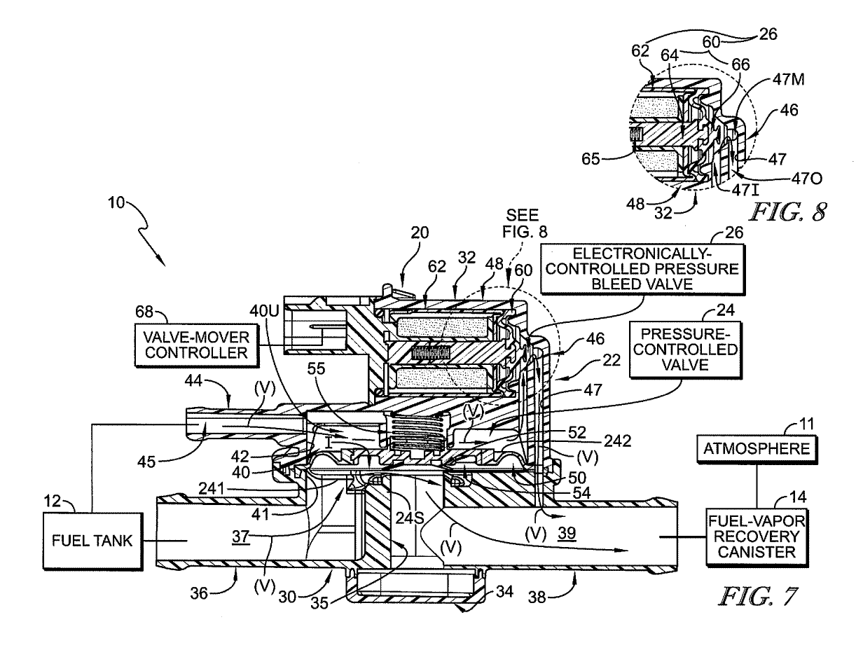

Tank venting system 10 includes a vent apparatus 20 coupled to fuel tank 12 via a tank conduit and to fuel vapor recovery canister 14 via a canister conduit as suggested in FIG. 1. Vent apparatus 20 includes a multi-piece housing 22, a pressure-controlled valve 24, and an electronically-controlled pressure bleed valve 26. Pressure-controlled valve 24 is configured to selectively allow a relatively large volume of fuel vapor to flow from the tank 12 to the canister 14 to relieve unwanted tank pressure conditions as suggested in FIG. 7. Electronically-controlled pressure bleed valve 26 is configured to selectively allow a relatively small volume of fuel vapor to flow to atmosphere 11 from housing 22 and thereby control pressures applied to pressure-controlled valve 24 as suggested in FIG. 6. Because electronically-controlled pressure bleed valve 26 need only control a relatively small-volume of vapor flow, the power required to control the flow is less than if controlling a relatively-large volume of flow.

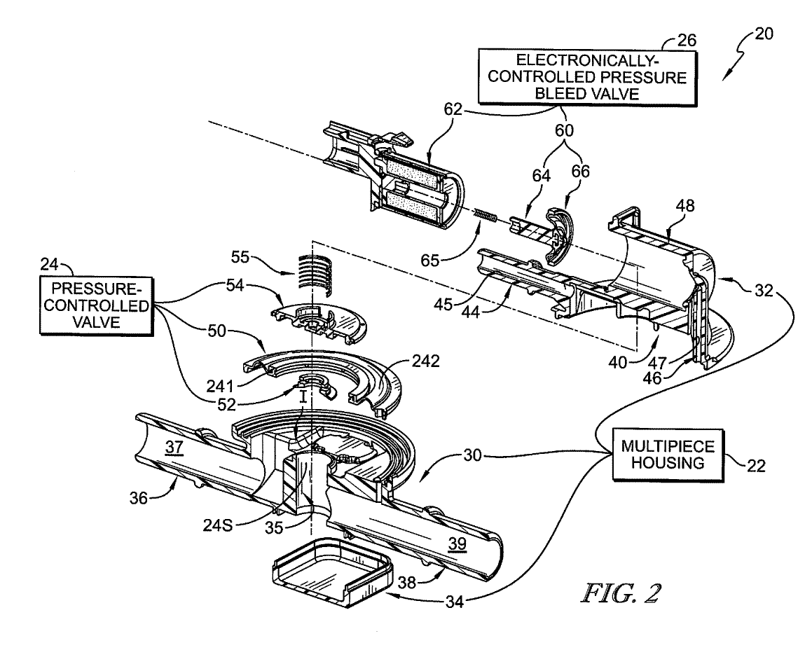

Multi-piece housing 22 forms various passageways for conducting gasses moving between the fuel tank 12 and the fuel vapor recovery canister 14 as suggested in FIGS. 1 and 2. Housing 22 illustratively includes a body 30, a cap 32, and a floor 34 as shown in FIG. 2. Body 30 provides passageways 37, 39 for fluidly coupling fuel tank 12 with canister 14 sized for relatively-large fuel vapor flows that are controlled by pressure-controlled valve 24. Cap 32 is coupled to body 30 and provides passageways 45, 47 sized for relatively-small fuel vapor flows that are controlled by electronically-controlled valve 26. Body 30 and cap 32 cooperate to define a valve compartment 40 that is divided into a lower portion 41 and an upper portion 42 by pressure-controlled valve 24 as shown in FIG. 1.

Body 30 is formed to include a tank pipe 36 coupled to fuel tank 12 and a canister pipe 38 coupled to canister 14 as shown in FIG. 2. Tank pipe 36 defines a tank passageway 37 that fluidly interconnects tank 12 with lower portion 41 of valve compartment 40. Canister pipe 38 defines a canister passageway 39 that fluidly interconnects a compartment pipe 35 extending from lower portion 41 of valve compartment 40 with canister 14. Both tank passageway 37 and canister passageway 39 are sized to conduct a relatively-large fuel vapor flow. Pressure-controlled valve 24 selectively blocks or allows fuel vapor to flow through compartment pipe 35 from lower portion 41 of valve compartment 40 into canister passageway 39 of canister pipe 38 to thereby control relatively-large vapor flow as suggested in FIGS. 3 and 7.

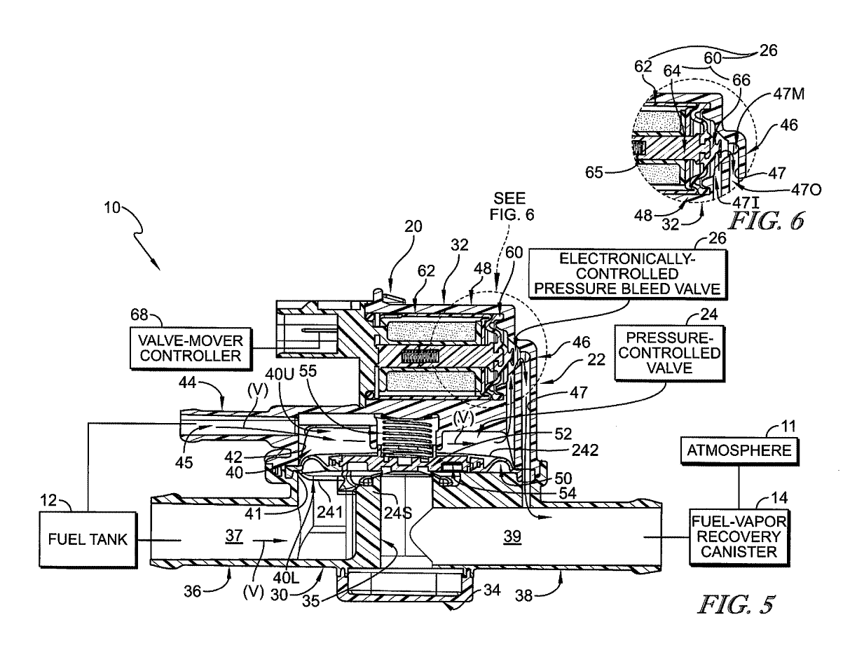

Cap 32 mounts to body 30 and is formed to include a valve-control pipe 44 coupled to fuel tank 12, a bleed pipe 46 coupled indirectly to atmosphere 11, and a valve cup 48 as shown in FIG. 2. Valve-control pipe 44 defines a valve pressurization passageway 45 that fluidly interconnects fuel tank 12 with upper portion 42 of valve compartment 40. Bleed pipe 46 defines a bleed passageway 47 that fluidly interconnects upper portion 42 of valve compartment 40 with canister passageway 39 that leads through canister 14 to atmosphere 11. Bleed passageway 47 is sized to conduct a relatively-small fuel vapor flow. Valve cup 48 receives and supports electronically-controlled valve 26. Electronically-controlled valve 26 selectively blocks or allows fuel vapor to flow from upper portion 42 of valve compartment 40 through bleed passageway 47 to atmosphere 11 as suggested in FIGS. 5 and 6.

A first vapor flow path provided by housing 22 is sized to conduct a relatively-large volume of fuel vapor flow as suggested in FIG. 7. The first vapor flow path is defined by tank pipe 36, lower portion 41 of valve compartment 40, compartment pipe 35, and canister pipe 38 as shown in FIG. 7. Pressure-controlled valve 24 is configured to regulate flow along the first vapor flow path as suggested in FIGS. 3 and 7.

A second vapor flow path provided by housing 22 is sized to conduct a relatively-small volume of fuel vapor flow (smaller than that carried through first vapor flow path) as suggested in FIG. 5-8. The second vapor flow path is defined by valve-control pipe 44, upper portion 42 of valve compartment 40, bleed pipe 46, and canister pipe 38. Electronically-controlled valve 26 is configured to regulate flow along the second vapor flow path as suggested in FIGS. 3-8.

Pressure-controlled valve 24, sometimes called primary valve 24, is configured to control relatively-large flows of fuel vapor from fuel tank 12 to canister 14 and, in turn, atmosphere 11 as suggested in FIGS. 3, 5, and 7. Such relatively-large flows may be allowed during refueling of fuel tank 12 or during operation of a vehicle engine burning fuel from fuel tank 12. In a closed position, pressure-controlled valve 24 blocks flow from lower portion 41 of valve compartment 40 into compartment pipe 35 thereby cutting off flow from tank pipe 36 to canister pipe 38. In an opened position, pressure-controlled valve 24 allows flow from lower portion 41 of valve compartment 40 into compartment pipe 35 thereby opening flow from tank pipe 36 to canister pipe 38.

Pressure-controlled valve 24 illustratively includes a deformable diaphragm 50, a seal ring 52, and a divider plate 54 that interconnects deformable diaphragm 50 and seal ring 52 as shown in FIG. 2. Deformable diaphragm 50 is mounted to housing 22 by trapping deformable diaphragm 50 between body 30 and cap 32 of housing 22 and is configured to deform based upon pressure in first and second portions 41, 42 of valve compartment 40. Seal ring 52 is coupled to plate 54 for movement therewith and is shaped/arranged to engage compartment pipe 35 of housing 22 when pressure-controlled valve 24 is closed. Divider plate 54 is coupled to deformable diaphragm 50 such that divider plate 54 is movable within valve compartment 40 upon deformation of diaphragm 50 to carry seal ring 52 into and out of contact with compartment pipe 35. A bias spring 55 is arranged between divider plate 54 and cap 32 of housing 22 to encourage the divider plate 54 toward compartment pipe 35 and bias pressure-controlled valve 24 toward the closed position.

Electronically-controlled valve 26 is configured to control the pressure in upper portion 42 of valve compartment 40 that is applied to pressure-controlled valve 24 so that pressure-controlled valve 24 opens and closes in response to opening and closing of electronically-controlled valve 26 as suggested in FIGS. 3-8. Electronically-controlled valve 26 controls relatively-small flows of fuel vapor from fuel tank to canister 14 and, in turn, to atmosphere 11 allowing valve 26 to be relatively small and easy to control. In a closed position, electronically-controlled valve 26 blocks flow through bleed passageway 47 as shown in FIGS. 3 and 4. In an opened position, electronically-controlled valve 26 allows flow through bleed passageway 47 as shown in FIGS. 5-8.

Electronically-controlled valve 26 is illustratively housed in valve cup 48 of cap 32 included in the housing 22 as shown in FIG. 1. Electronically-controlled valve 26 includes a stopper 60 and an electro-magnetic actuator 62 as shown in FIG. 2. Stopper 60 is made up of an armature 64 and an overmolded diaphragm 66. Electro-magnetic actuator 62 is electrically coupled to a valve-mover controller 68 and is configured to move stopper 60 between a closed position blocking flow through bleed passageway 47 and an opened position allowing flow through bleed passageway 47. A return spring 65 is arranged to bias stopper 60 toward the closed position blocking fuel vapor from flowing from control pipe 46 to canister pipe 38 through housing 22.

In some embodiments, vacuum and/or pressure relief valves can be incorporated into vent apparatus 20 to accommodate fault modes of the electronically-controlled valve 26. A vacuum relief valve may be configured to allow vapor to flow from canister 14 (and atmosphere 11) to tank 12 upon a large enough vacuum pressure developing in tank 12. A pressure relief valve may be configured to allow vapor to flow from tank 12 to canister 14 (and atmosphere 11) upon a large enough pressure developing in tank 12.

In operation, to open the pressure-controlled valve 24 thereby allowing a relatively large flow of fuel vapor to move from tank 12 to canister 14, an electrical signal is generated by valve-mover controller 68 associated with opening of electronically-controlled valve 26. The electrical signal may be generated in response to a user opening an outer fuel door of a vehicle indicative that the use may be about to refuel the vehicle. Upon receipt of the electrical signal, electro-magnetic actuator 62 moves stopper 60 to allow a relatively small flow of fuel vapor from upper portion 42 of valve compartment 40 toward canister 14 and atmosphere 11 as suggested in FIGS. 5 and 6.

The relatively small flow of fuel vapor out from upper portion 42 of valve compartment 40 reduces the pressure in upper portion 42 to a level lower than that in lower portion 41 of valve compartment 40 such that pressure-controlled valve 24 moves from its normally closed position to the open position as suggested in FIG. 7. When pressure-controlled valve 24 is in the opened position, a relatively-large flow of fuel vapor can move from fuel tank 12 to canister 14 and atmosphere 11.

The following numbered clauses include embodiments that are contemplated and non-limiting:

Clause 1. A tank venting system adapted for use in a vehicle, the system comprising

a fuel tank configured to store liquid fuel,

a fuel vapor recovery canister located outside the fuel tank and configured to capture and store hydrocarbons entrained in fuel vapors that are displaced and generated in the fuel tank during a typical vehicle refueling operation or that are otherwise vented from the fuel tank, and

a vent apparatus for regulating flow of fuel vapor between the fuel tank and the fuel vapor recovery canister, the vent apparatus including a housing coupled fluidly to the fuel tank and the fuel vapor recovery canister, a primary valve mounted in the housing and configured to block or allow a first volume of fuel vapor to flow from the fuel tank to the fuel vapor recovery canister to relieve unwanted tank pressure based on pressures applied to the primary valve, and a bleed valve mounted in the housing and configured to provide means for controlling pressures applied to the primary valve by blocking or allowing a second volume of fuel vapor, smaller than the first volume of fuel vapor, to flow from the housing to the fuel vapor recovery canister in response to an electrical input so that the electrical power required to block or allow the relatively-large first volume of fuel vapor flow controlled by the primary valve is less than that required for direct electronic control of the primary valve.

Clause 2. The system of any other suitable clause, wherein the housing of the vent apparatus defines a valve compartment, the primary valve includes a deformable diaphragm that, at least in part, divides the valve compartment into a first portion and a second portion, and the bleed valve is configured to block or allow the second volume of fuel vapor to flow from the second portion of the valve compartment to the fuel vapor recovery canister in order to change the pressures applied to the primary valve.

Clause 3. The system of any other suitable clause, wherein the primary valve is biased toward a closed position arranged to block the relatively-large first volume of fuel vapor from flowing by a bias spring.

Clause 4. The system of any other suitable clause, wherein the bleed valve includes a stopper movable from a closed position to an opened position and an electro-magnetic actuator configured to move the stopper between the closed position and the opened position, and a return spring is arranged to bias the stopper toward the closed position.

Clause 5. The system of any other suitable clause, wherein the stopper includes an armature that extends into the electro-magnetic actuator and a diaphragm that is overmolded onto a portion of the armature arranged outside the electro-magnetic actuator.

Clause 6. The system of any other suitable clause, wherein the first portion of the valve compartment is coupled fluidly to the fuel tank by a tank pipe formed by the housing and the second portion of the valve compartment is coupled fluidly to the fuel tank by a valve-control pipe formed by the housing.

Clause 7. The system of any other suitable clause, wherein the housing forms a canister pipe coupled fluidly to the fuel vapor recovery canister, the primary valve is configured to block or allow the relatively-large first volume of fuel vapor to flow from the valve compartment to the canister pipe, and the bleed valve is configured to block or allow the relatively-small second volume of fuel vapor to flow from the valve compartment to the canister pipe.

Clause 8. The system of any other suitable clause, further comprising a valve-mover controller coupled to the bleed valve and configured to provide an electrical input to the bleed valve associated with opening of the bleed valve in response to action indicative that the user may be about to refuel the fuel tank.

Clause 9. The system of any other suitable clause, wherein the valve-mover controller is configured to provide an electrical input to the bleed valve associated with opening of the bleed valve in response to a user opening an outer fuel door of a vehicle associated with the system indicative that the user may be about to refuel the fuel tank.

Clause 10. A tank venting system adapted for use in a vehicle, the system comprising

a fuel tank configured to store liquid fuel,

a fuel vapor recovery canister located outside the fuel tank, and

a vent apparatus including a housing coupled fluidly to the fuel tank and the fuel vapor recovery canister, a pressure-controlled valve mounted in a valve compartment formed by the housing and configured to block or allow a first volume of fuel vapor to flow from the fuel tank to the fuel vapor recovery canister along a first flow path, and an electronically-controlled valve mounted in the housing and configured to selectively allow a second volume of fuel vapor, smaller than the first volume of fuel vapor, to flow from a portion of the valve compartment formed by the housing to the fuel vapor recovery canister along second flow path.

Clause 11. The system of any other suitable clause, wherein the pressure-controlled valve includes a deformable diaphragm that, at least in part, divides the valve compartment into a first portion and a second portion, and the electronically-controlled valve is configured to block or allow the second volume of fuel vapor to flow along the second flow path from the second portion of the valve compartment to the fuel vapor recovery canister.

Clause 12. The system of any other suitable clause, wherein the pressure-controlled valve is biased toward a closed position arranged to block the relatively-large first volume of fuel vapor from flowing by a bias spring.

Clause 13. The system of any other suitable clause, wherein the electronically-controlled valve includes a stopper movable from a closed position to an opened position and an electro-magnetic actuator configured to move the stopper between the closed position and the opened position, and a return spring is arranged to bias the stopper toward the closed position.

Clause 14. The system of any other suitable clause, wherein the stopper includes an armature that extends into the electro-magnetic actuator and a diaphragm that is overmolded onto a portion of the armature arranged outside the electro-magnetic actuator.

Clause 15. The system of any other suitable clause, further comprising a valve-mover controller coupled to the electronically-controlled valve and configured to provide an electrical input to the electronically-controlled valve associated with opening of the bleed valve in response to action indicative that the user may be about to refuel the fuel tank.

Clause 16. The system of any other suitable clause, wherein the valve-mover controller is configured to provide an electrical input to the bleed valve associated with opening of the bleed valve in response to a user opening an outer fuel door of a vehicle associated with the system indicative that the user may be about to refuel the fuel tank.

Clause 17. A vent apparatus for regulating flow of fuel vapor between a fuel tank and a fuel vapor recovery canister in a vehicle, the apparatus comprising

a housing that forms a tank passageway configured to be coupled fluidly to the fuel tank, a canister passageway configured to be coupled fluidly to the fuel vapor recovery canister, and a valve compartment in fluid communication with the tank passageway and the canister passageway,

a pressure-controlled valve mounted in the valve compartment and movable from a normally closed position to an opened position to selectively allow a first volume of fuel vapor to flow from the tank passageway to the canister passageway along a first flow path based on pressures applied to the pressure-controlled valve, and

an electronically-controlled valve mounted in the housing and configured to move from a normally closed position to an opened position to selectively allow a second volume of fuel vapor, smaller than the first volume of fuel vapor, to flow from a portion of the valve compartment formed by the housing to the fuel canister passageway along second flow path in response to an electrical input so that pressures applied to the pressure-controlled valve are modified in order to cause the pressure-controlled valve to move to the opened position.

Clause 18. The apparatus or system of any other suitable clause, wherein the housing forms a bypass passageway that fluidly interconnects the valve compartment with the canister passageway and that is selectively blocked by the electronically-controlled valve.

Clause 19. The apparatus or system of any other suitable clause, wherein the pressure-controlled valve includes a deformable diaphragm that, at least in part, divides the valve compartment into a first portion and a second portion, and the electronically-controlled valve is configured to block or allow the second volume of fuel vapor to flow along the second flow path from the second portion of the valve compartment to the fuel vapor recovery canister.

Clause 20. The apparatus or system of any other suitable clause, wherein the housing forms a valve pressurization passageway, spaced apart from the tank passageway, that opens into the second portion of the valve compartment and is configured to be coupled fluidly to the fuel tank, and the housing forms a bypass passageway that fluidly interconnects the second portion of the valve compartment with the canister passageway.

1. A tank venting system adapted for use in a vehicle, the system comprising
a fuel tank configured to store liquid fuel,
a fuel-vapor recovery canister located outside the fuel tank and configured to capture and store hydrocarbons entrained in fuel vapors that are displaced and generated in the fuel tank during a typical vehicle refueling operation or that are otherwise vented from the fuel tank, and
a vent apparatus for regulating flow of fuel vapor between the fuel tank and the fuel-vapor canister, the vent apparatus including a housing coupled fluidly to the fuel tank and the fuel-vapor recovery canister, a primary valve mounted in the housing and configured to block or allow a relatively large first volume of fuel-vapor to flow from the fuel tank to the fuel-vapor recovery canister to relieve unwanted tank pressure based on pressures applied to the primary valve, and a bleed valve mounted in the housing and configured to provide means for controlling pressures applied to the primary valve by blocking or allowing a second volume of fuel vapor, smaller than the first volume of fuel vapor, to flow from the housing to the fuel-vapor recovery canister in response to an electrical input so that the electrical power required to block or allow the relatively large first volume of fuel vapor flow controlled by the primary valve is less than that required for direct electronic control of the primary valve.

2. The system of claim 1, wherein the housing of the vent apparatus defines a valve compartment, the primary valve includes a deformable diaphragm that, at least in part, divides the valve compartment into a first portion and a second portion, and the bleed valve is configured to block or allow the second volume of fuel vapor to flow from the second portion of the valve compartment to the fuel-vapor recovery canister in order to change the pressures applied to the primary valve.

3. The system of claim 2, wherein the primary valve is biased toward a closed position arranged to block the relatively large first volume of fuel vapor from flowing by a bias spring.

4. The system of claim 2, wherein the bleed valve includes a stopper movable from a closed position to an opened position and an electro-magnetic actuator configured to move the stopper between the closed position and the opened position, and a return spring is arranged to bias the stopper toward the closed position.

5. The system of claim 4, wherein the stopper includes an armature that extends into the electro-magnetic actuator and a diaphragm that is overmolded onto a portion of the armature arranged outside the electro-magnetic actuator.

6. The system of claim 2, wherein the first portion of the valve compartment is coupled fluidly to the fuel tank by a tank pipe formed by the housing and the second portion of the valve compartment is coupled fluidly to the fuel tank by a valve-control pipe formed by the housing.

7. The system of claim 6, wherein the housing forms a canister pipe coupled fluidly to the fuel-vapor recovery canister, the primary valve is configured to block or allow the relatively large first volume of fuel vapor to flow from the valve compartment to the canister pipe, and the bleed valve is configured to block or allow a relatively small second volume of fuel vapor to flow from the valve compartment to the canister pipe.

8. The system of claim 1, further comprising a valve-mover controller coupled to the bleed valve and configured to provide an electrical input to the bleed valve associated with opening of the bleed valve in response to action indicative that the user may be about to refuel the fuel tank.

9. The system of claim 8, wherein the valve-mover controller is configured to provide an electrical input to the bleed valve associated with opening of the bleed valve in response to a user opening an outer fuel door of a vehicle associated with the system indicative that the user may be about to refuel the fuel tank.

10. A tank venting system adapted for use in a vehicle, the system comprising
a fuel tank configured to store liquid fuel,
a fuel-vapor recovery canister located outside the fuel tank, and
a vent apparatus including a housing coupled fluidly to the fuel tank and the fuel-vapor recovery canister, a pressure-controlled valve mounted in a valve compartment formed by the housing and configured to block or allow a relatively larger first volume of fuel vapor to flow from the fuel tank to the fuel vapor recovery canister along a first flow path, and an electronically-controlled pressure bleed valve mounted in the housing and configured to selectively allow a relatively smaller second volume of fuel vapor, smaller than the first volume of fuel vapor, to flow from a portion of the valve compartment formed by the housing to the fuel-vapor recovery canister along second flow path.

11. The system of claim 10, wherein the pressure-controlled valve includes a deformable diaphragm that, at least in part, divides the valve compartment into a first portion and a second portion, and the electronically-controlled pressure bleed valve is configured to block or allow the relatively smaller second volume of fuel vapor to flow along the second flow path from the second portion of the valve compartment to the fuel-vapor recovery canister.

12. The system of claim 10, wherein the pressure-controlled valve is biased toward a closed position arranged to block the relatively large first volume of fuel vapor from flowing by a bias spring.

13. The system of claim 12, wherein the electronically-controlled pressure bleed valve includes a stopper movable from a closed position to an opened position and an electro-magnetic actuator configured to move the stopper between the closed position and the opened position, and a return spring is arranged to bias the stopper toward the closed position.

14. The system of claim 13, wherein the stopper includes an armature that extends into the electro-magnetic actuator and a diaphragm that is overmolded onto a portion of the armature arranged outside the electro-magnetic actuator.

15. The system of claim 10, further comprising a valve-mover controller coupled to the electronically-controlled pressure bleed valve and configured to provide an electrical input to the electronically-controlled pressure bleed valve associated with opening of the electronically-controlled pressure bleed valve in response to action indicative that the user may be about to refuel the fuel tank.

16. The system of claim 15, wherein the valve-mover controller is configured to provide an electrical input to the electronically-controlled pressure bleed valve associated with opening of the electronically-controlled pressure bleed valve in response to a user opening an outer fuel door of a vehicle associated with the system indicative that the user may be about to refuel the fuel tank.

17. A vent apparatus for regulating flow of fuel vapor between a fuel tank and a fuel-vapor recovery canister in a vehicle, the apparatus comprising
a housing that forms a tank passageway configured to be coupled fluidly to the fuel tank, a canister passageway configured to be coupled fluidly to the fuel vapor recovery canister, and a valve compartment in fluid communication with the tank passageway and the canister passageway,
a pressure-controlled valve mounted in the valve compartment and movable from a normally closed position to an opened position to selectively allow a first volume of fuel vapor to flow from the tank passageway to the canister passageway along a first flow path based on pressures applied to the pressure-controlled valve, and
an electronically-controlled pressure bleed valve mounted in the housing and configured to move from a normally closed position to an opened position to selectively allow a second volume of fuel vapor, smaller than the first volume of fuel vapor, to flow from a portion of the valve compartment formed by the housing to the canister passageway along second flow path in response to an electrical input so that pressures applied to the pressure-controlled valve are modified in order to cause the pressure-controlled valve to move to the opened position.

18. The apparatus of claim 17, wherein the housing forms a bypass passageway that fluidly interconnects the valve compartment with the canister passageway and that is selectively blocked by the electronically-controlled pressure bleed valve.

19. The apparatus of claim 17, wherein the pressure-controlled valve includes a deformable diaphragm that, at least in part, divides the valve compartment into a first portion and a second portion, and the electronically-controlled pressure bleed valve is configured to block or allow the second volume of fuel vapor to flow along the second flow path from the second portion of the valve compartment to the fuel-vapor recovery canister.

20. The apparatus of claim 19, wherein the housing forms a valve-pressurization passageway, spaced apart from the tank passageway, that opens into the second portion of the valve compartment and is configured to be coupled fluidly to the fuel tank, and the housing forms a bypass passageway that fluidly interconnects the second portion of the valve compartment with the canister passageway.

21. A tank venting system comprising
a housing formed to include a tank passageway adapted to be coupled in fluid communication to a fuel tank and a canister passageway adapted to be coupled in fluid communication to a fuel-vapor recovery canister and arranged to open into the tank passageway, the housing also being formed to include a valve seat at a fluid-conducting interface between the tank and the canister passageways,
a pressure-controlled valve having a first side exposed to fuel vapor extant in the tank and canister passageways and an opposite second side exposed to fuel vapor extant in the fuel tank that is communicated to the opposite second side via a valve-pressurization passageway exposed to fuel vapor extant in the fuel tank, the pressure-controlled valve being mounted for movement relative to the housing to a closed position wherein the first side engages the valve seat to block flow of fuel vapor between the tank and canister passageways and an opened position wherein the first side disengages the valve seat to allow flow of fuel vapor between the tank and canister passageways, and
valve-opening means for lowering pressure of fuel vapor exposed to the opposite second side of the pressure-controlled valve by venting pressurized fuel vapor that has been communicated via the valve-pressurization passageway to the opposite second side of the pressure-controlled valve into the canister passageway through a bleed passageway for discharge into the atmosphere in response to an electrical input so that the pressure-controlled valve moves from the closed position away from the valve seat to the opened position to allow pressurized fuel vapor to flow from the tank passageway into the canister passageway through the fluid-conducting interface between the tank and canister passageways.

22. The tank venting system of claim 21, wherein the housing is formed to include the bleed passageway and the valve-opening means includes an electronically controlled pressure bleed valve associated with the housing and arranged to lie normally in a flow-blocking position to block flow of pressurized fuel vapor from the valve-pressurization passageway to the canister passageway through the bleed passageway and wherein the electronically controlled pressure bleed valve is arranged to move from the flow-blocking position to a flow-allowing position to allow flow of pressurized fuel vapor from the valve-pressurization passageway to the canister passageway through the bleed passageway to lower pressure of pressurized fuel vapor exposed to the opposite second side of the pressure-controlled valve in response to the electrical input to cause the pressure-controlled valve to move from the closed position away from the valve seat to the opened position to allow pressurized fuel vapor to flow from the tank passageway into the canister passageway.

23. The tank venting system of claim 22, wherein the housing is formed to include the valve-pressurization passageway.

24. The tank venting system of claim 22, wherein the housing includes a body including the valve seat, a tank pipe that is formed to include the tank passageway, and a canister pipe that is formed to include the canister passageway, the housing also includes a cap coupled to the body form a valve compartment containing the pressure-controlled valve to allow movement of the pressure-controlled valve between the closed and opened positions, the pressure-controlled valve is arranged to divide the valve compartment into a lower portion bounded in part by the first side of the pressure-controlled valve and a separate upper portion bounded in part by the opposite second side of the pressure-controlled valve, the body includes a valve-control pipe that is formed to include the valve-pressurization passageway and to cause the valve-pressurization passageway to communicate with the upper portion of the valve compartment, and the cap includes a bleed pipe that is formed to include the bleed passageway and to cause an inlet end of the bleed passageway to communicate with the upper portion of the valve compartment and an outlet end of the bleed passageway to communicate with the canister passageway.

25. The tank venting system of claim 24, wherein the valve-opening means includes a stopper that is arranged to extend into the bleed passageway formed in the bleed pipe and move relative to the bleed pipe during movement of the electronically controlled pressure bleed valve between the flow-allowing and flow-blocking positions to regulate flow of pressurized fuel vapor from the upper portion of the valve compartment to the canister passageway via the bleed passageway.

26. The tank venting system of claim 25, wherein the bleed passageway includes an outer flow section arranged to lie in spaced-apart relation to the upper portion of the valve compartment and to communicate with the canister passageway, an inner flow section arranged to lie between the upper portion of the valve compartment and the outer flow section and to communicate with the upper portion of the valve compartment, and a medial flow section arranged to interconnect the inner and outer flow sections and receive the stopper therein during movement of the electronically controlled pressure bleed valve to the flow-blocking position.

27. The tank venting system of claim 22, wherein the pressure-controlled valve is arranged to lie between the electronically controlled pressure bleed valve and the valve seat included in the housing.

28. The tank venting system of claim 27, further comprising a bias spring acting between the housing and the opposite second side of the pressure-controlled valve normally to yieldably urge the pressure-controlled valve to the closed position.

29. The tank venting system of claim 28, wherein the bias spring is a coiled compression spring exposed to fuel vapor flowing from the valve-pressurization passageway into the bleed passageway.

30. The tank venting system of claim 28, wherein the bias spring is arranged to lie between the electronically controlled pressure bleed valve and the pressure-controlled valve.

31. The tank venting system of claim 22, wherein the housing is formed to include the bleed passageway.

32. The tank venting system of claim 31, wherein the housing is formed to include a valve compartment containing the pressure-controlled valve and interconnecting the valve-pressurization passageway and the bleed passageway in fluid communication.

33. The tank venting system of claim 32, wherein the pressure-controlled valve is arranged to divide the valve compartment into a lower portion bounded in part by the first side of the pressure-controlled valve and a separate upper portion bounded in part by the opposite second side of the pressure-controlled valve and arranged to communicate pressurized fuel vapor from the valve-pressurization passageway to the bleed passageway.

34. The tank venting system of claim 33, further comprising a bias spring located in the separate upper portion of the valve compartment and arranged to act between the housing and the opposite second side of the pressure-controlled valve normally to yieldably urge the pressure-controlled valve to the closed position.
